(19) United States
(12) Patent Application Publication
(10) Pub. No.: US 2025/0086705 A1
(43) Pub. Date: Mar. 13, 2025

(54) INTELLIGENT PROVISION OF FINANCIAL SERVICES WITHIN A FINANCIAL SERVICES PLATFORM

(71) Applicant: Sivo Holdings Limited, San Francisco, CA (US)

(72) Inventors: Katharine Mary Hiscox, Vancouver (CA); Mariana Daniela Conejo Rico, Vancouver (CA); Mario DeSousa, Sudbury, MA (US)

(21) Appl. No.: 18/243,363

(22) Filed: Sep. 7, 2023

(51) Int. Cl. G06Q 40/03; G06F 40/20; G06Q 50/00

(52) U.S. Cl. CPC G06Q 40/03; G06F 40/20; G06Q 50/01

(57) ABSTRACT

Methods and systems provide for the intelligent provision of financial services within a financial services platform. In one embodiment, the system: extracts unstructured data from external sources associated with a new or existing user of a financial services platform; generates or updates a user profile, including a user risk assessment, from the unstructured data; presents a financial offer to the user for a financial service or product; upon receiving an indication of interest from the user, matches the user to one or more pieces of invitational content with product or service offers; presents the invitational content to the user; upon the user has accepted an offer, receives a fee from the brand that is used to fund aspects of the financial service or product; and periodically performs one or more of the above steps for additional financial offers and additional pieces of invitational content.

### FIELD OF INVENTION

Various embodiments relate generally to financial services, and more particularly, to systems and methods for the intelligent provision of financial services within a financial services platform.

### SUMMARY

The appended claims may serve as a summary of this application.

### BRIEF DESCRIPTION OF THE DRAWINGS

The present invention relates generally to financial services, and more particularly, to systems and methods for the intelligent provision of financial services within a financial services platform.

The present disclosure will become better understood from the detailed description and the drawings, wherein:

FIG. 1 is a diagram illustrating an exemplary environment in which some embodiments may operate.

FIG. 2 is a diagram illustrating an exemplary computer system that may execute instructions to perform some of the methods herein.

FIG. 3 is a flow chart illustrating an exemplary method that may be performed in some embodiments.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In the realm of provision of financial services such as, e.g., credit assessment and credit limit extensions, traditional methodologies have predominantly relied upon rigid and static models. Historically, creditworthiness determination has predominantly been based on financial history, credit scores, and other structured financial data. Such approaches, while offering a certain degree of predictability, often fail to capture the nuanced and dynamic aspects of an individual's financial circumstances. Moreover, the increasingly interconnected nature of the digital age has paved the way for the integration of non-traditional data sources, presenting opportunities for more comprehensive and accurate credit evaluations.

Existing credit evaluation methods have limitations in accommodating the evolving financial landscape. These conventional methods often fail to consider the potential influence of social interactions, lifestyle preferences, and brand engagements on an individual's financial behaviors. Moreover, the deployment of such methodologies remains predominantly linear, with minimal flexibility in adapting to the changing financial aspirations and needs of users.

In light of these limitations, there exists a critical need for an innovative approach that harnesses the potential of unstructured data, such as social media interactions, to provide a more holistic understanding of an individual's financial behavior and preferences. The current state of credit assessment requires a solution that seamlessly integrates various data sources, adapts to user-specific attributes, and presents tailored financial opportunities that resonate with individual aspirations.

In one embodiment, the system: extracts unstructured data from one or more external sources associated with a user, where the user is either a new user or an existing user of a financial services platform; generates or updates a user profile, including a user risk assessment, from the unstructured data; presents a financial offer to the user for a financial service or product; upon receiving an indication of interest from the user, matches the user to one or more pieces of invitational content each associated with a brand and corresponding to a product or service offer from the brand; presents the invitational content to the user; upon receiving indication that the user has accepted the product or service offer, receives a fee from the brand that is used to fund aspects of the financial service or product; and periodically performs one or more of the above steps for additional financial offers and additional pieces of invitational content.

Further areas of applicability of the present disclosure will become apparent from the remainder of the detailed description, the claims, and the drawings. The detailed description and specific examples are intended for illustration only and are not intended to limit the scope of the disclosure.

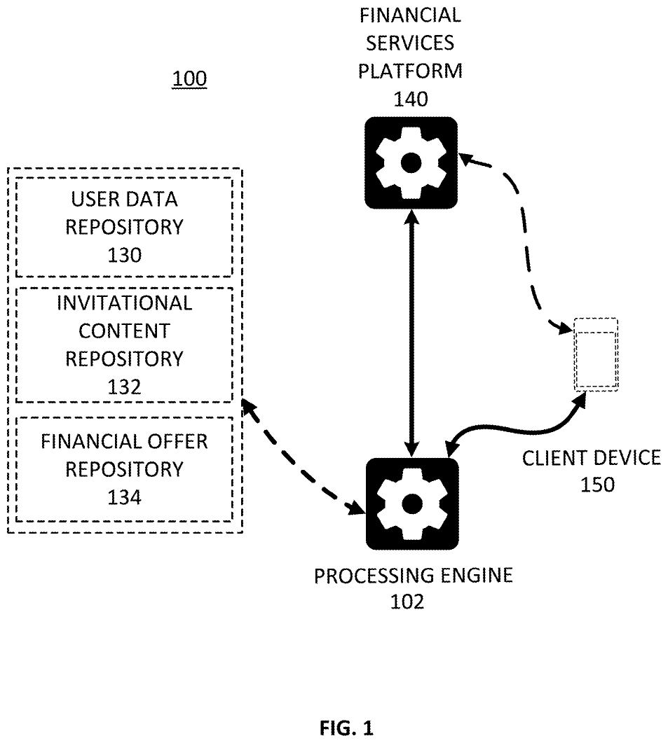

FIG. 1 is a diagram illustrating an exemplary environment in which some embodiments may operate. In the exemplary environment 100, a client device 150 is connected to a processing engine 102 and a financial services platform 140. The processing engine 102 is connected to the financial services platform 140, and optionally connected to one or more repositories and/or databases, including, e.g., a user data repository, an invitational content repository, and a financial offer repository. One or more of the databases may be combined or split into multiple databases. The client device 150 in this environment may be a computer, and the financial services platform 140 and processing engine 102 may be applications or software hosted on a computer or multiple computers which are communicatively coupled via remote server or locally.

The exemplary environment 100 is illustrated with only one client device, one processing engine, and one financial services platform, though in practice there may be more or fewer additional client devices, processing engines, and/or financial services platforms. In some embodiments, the client device(s), processing engine, and/or financial services platform may be part of the same computer or device.

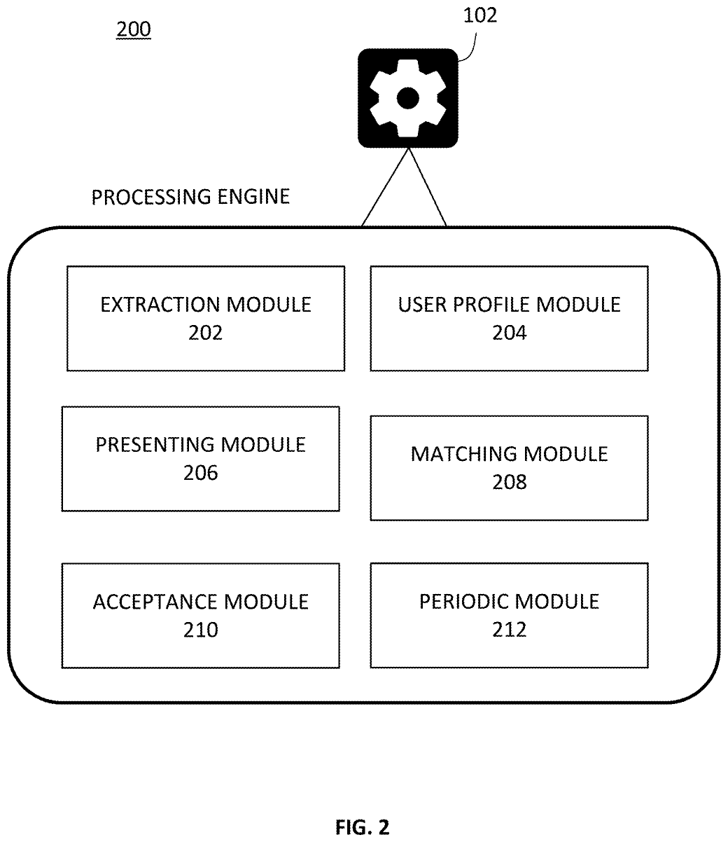

In an embodiment, the processing engine 102 may perform the exemplary method of FIG. 2 or other method herein and, as a result, provide for the intelligent provision of financial services within a financial services platform. In some embodiments, this may be accomplished via communication with the client device, processing engine, financial services platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

FIG. 2 is a diagram illustrating an exemplary computer system that may execute instructions to perform some of the methods herein. An exemplary computer system 200 is shown with software modules that may execute some of the functionality described herein. In some embodiments, the modules illustrated are components of the processing engine 202.

Extraction module 202 functions to extract unstructured data from one or more external sources associated with a user, where the user is either a new or existing user of a financial services platform.

User profile module 204 functions to generate or update a user profile from the unstructured data.

Presenting module 206 functions to present, to the user, a financial offer for a financial service or product; and also functions to present one or more matching pieces of invitational content to the user.

Matching module 208 functions to, upon receiving an indication of interest from the user, match the user to one or more pieces of invitational content each associated with a brand and corresponding to a product or service offer from the brand.

Acceptance module 210 functions to, upon receiving indication that the user has accepted the product or service offer for one of the pieces of invitational content, receive a fee from the brand, where at least a portion of the fee is used to fund one or more aspects of the financial service or product.

Periodic module 212 functions to periodically perform one or more of the above steps for additional financial offers and additional pieces of invitational content.

Such functions will be described in further detail below.

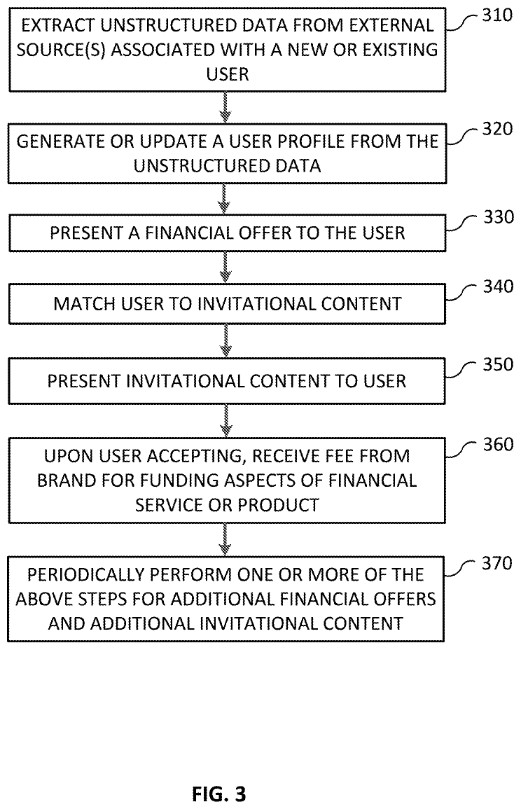

FIG. 3 is a flow chart illustrating an exemplary method that may be performed in some embodiments.

At step 310, the system extracts unstructured data from one or more external sources associated with a user, where the user is either a new or existing user of a financial services platform.

In some embodiments, the “financial services platform” as used herein may refer to a digital or online ecosystem, which may be provided by, e.g., a financial technology company, financial institution, or other financial services provider. This platform may provide a range of, e.g., financial services, products, tools, offers, and/or instruments to individuals and/or enterprises. This platform may often be presented through, e.g., a web-based or mobile application. In various embodiments, the financial services offered by the platform may include, for example, extending credit (including, e.g., provision of credit cards), extending loans, and/or the provision of, e.g., cash back offers, savings offers, insurance products (e.g., life and auto insurance), financial investments (e.g., stocks and mutual funds), and more.

In some embodiments, the user may be a new user to the platform. In some embodiments, for new users, the steps in the method may represent an onboarding of the user within the financial services platform. New users may undergo a more extensive data extraction process than existing users to generate and establish their user profiles. In some embodiments, existing users may already have an existing user profile within the financial services platform, and the extraction process involves a periodic updating and enhancing of the user profile with new, updated data from external sources. This may ensure that the user profile of an existing user remains current and reflective of the user's evolving financial behavior and preferences. In some embodiments, the system periodically ensures that such existing user profiles are continually refined and augmented to deliver tailored financial offers and/or invitational content more effectively. In some embodiments, the differentiation between new and existing users may serve as a foundational step in the method as a whole, effecting aspects such as user profile generation, financial offer presentation, and matching with invitational content, as will be described in detail further below.

In some embodiments where a new user is engaging with the financial services platform for the first time, the new user has been presented with a financial offer, and has accepted the offer or at least engaged with the presented offer or indicated interest in some way. For example, the user may be presented with an offer to sign up for a credit card or apply for a loan, and the user is presented with this offer via a presentation of invitational content on a web page, such as, e.g., an advertisement. This represents a financial offer. By clicking or interacting with this offer, the user accepts or otherwise expresses interest in the offer. In some embodiments, the system may then begin an onboarding process of the user for the financial services platform. In some embodiments, the user is prompted to provide some information about themselves, and the user enters some information into a text field in response. In some embodiments, this may be fairly limited information. For example, the information may be limited to one or more of, e.g., a full name, an email address, a phone number, a username, and a location (e.g., a city and state). In some embodiments, the system may then use and further enrich this limited information using one or more external sources to extract unstructured data. For example, in some embodiments, one or more external sources may match a user to a user profile using one or more pieces of this limited information. Further unstructured data about the user may be available publicly from this user profile. In some embodiments, a user may choose to “opt in” to the system obtaining such data before any such extraction from external sources takes place.

In some embodiments, the system gathers unstructured data from external sources closely linked to a particular user. Unstructured data refers to information lacking a predetermined format, making it challenging to process using traditional data manipulation methods. In some embodiments, these external sources may encompass various platforms and services that have a connection with the user, ranging from, e.g., social media accounts such as LinkedIn, Facebook, and Instagram to financial accounts, to other online repositories containing user-generated or third-party generated content. Through this process, a comprehensive view of the user's interactions, behaviors, and preferences can be obtained.

In some embodiments, the process of extracting unstructured data from external sources can involve leveraging advanced data acquisition techniques to gather information from a diverse range of platforms. For instance, in some embodiments, the method may employ web crawling algorithms to navigate social media profiles, capturing posts, comments, and interactions that provide insights into the user's preferences. Additionally in some embodiments, Application Programming Interfaces (hereinafter “APIs”) may be utilized to fetch unstructured data from various sources, enabling the method to tap into different ecosystems seamlessly.

In some embodiments, the unstructured data extraction can encompass linguistic analysis techniques, such as, e.g., sentiment analysis and/or named entity recognition. These techniques can help in discerning, for example, the user's emotional tone, sentiments, and identifying entities such as brand names, products, or locations mentioned in their posts. This linguistic analysis can serve to enhance the quality of the user profile by adding a nuanced layer of understanding to the extracted data.

In some embodiments, the method can incorporate one or more artificial intelligence (hereinafter “AI”) models trained specifically for unstructured data extraction. These models may be fine-tuned to interpret specific types of content, such as, e.g., images or short text snippets, allowing for a more refined extraction process. For example, a convolutional neural network (hereinafter “CNN”) can be applied to analyze images posted by the user, extracting visual cues that offer insights into their hobbies or interests.

In some embodiments, the unstructured data extraction can involve natural language processing techniques to understand the context of the user's interactions. For instance, by analyzing the sequence of posts and reactions, the method can infer trends and shifts in the user's preferences over time. The use of context-aware techniques ensures that the extracted unstructured data is not viewed in isolation, but instead as part of a cohesive narrative of the user.

In some embodiments, the method may incorporate one or more privacy-preserving mechanisms to ensure compliance with data protection regulations. Anonymization techniques can be applied to the extracted data to remove personally identifiable information, thus safeguarding the user's privacy while still allowing for insightful analysis.

In some embodiments, the unstructured data extraction can be parameterized based on user preferences. Users might have the option to specify which social media accounts or types of content they wish to include in their profile, granting them control over the scope of information extraction.

In some embodiments, the unstructured data extracted from external sources is dynamic and subject to change over time. For example, in some embodiments, as users continue to engage online, their digital footprint evolves, leading to fluctuations in their interests, interactions, and preferences. Therefore, the process of extracting unstructured data requires continuous monitoring and adaptation to accurately reflect the user's evolving online presence. This dynamic nature ensures that the user profile and engagement strategies remain relevant and effective.

In some embodiments, the data from the external sources includes financial transaction data and/or social media engagement data.

In some embodiments, financial transaction data encompasses a wide array of monetary interactions conducted by the user across various platforms and institutions. These transactions encompass everything from, e.g., purchases, payments, and investments to loans, deposits, and withdrawals. By incorporating this data, the method gains insights into the user's financial behaviors, preferences, and spending patterns. This financial transaction data serves as a powerful tool to assess the user's financial capacity, creditworthiness, and overall financial health.

In some embodiments, social media engagement data delves into, e.g., the user's interactions, interests, and affiliations within the digital sphere. In some embodiments, this type of data encompasses the user's posts, comments, reactions, and connections across social media platforms. It can provide a window into, for example, the user's personal interests, hobbies, professional affiliations, and social interactions. In some embodiments, by analyzing this data, the method can deduce the user's sentiments, preferences, and engagement with various topics, enabling the creation of a well-rounded user profile.

In some embodiments, the data from the external sources is retrieved and presented by a third party service. In this context, the term “third party service” refers to an external entity that specializes in, e.g., data aggregation, integration, or analysis. In some embodiments, this entity is entrusted with the task of gathering the necessary data from various external sources on behalf of the financial services platform. The third-party service's role is pivotal in streamlining the acquisition of external data, ensuring its accuracy, and preparing it for integration into the user profile creation process.

In some embodiments, such third party services are equipped with specialized tools, technologies, and expertise to navigate the complexities of data retrieval from diverse external sources. They can efficiently access, consolidate, and process data from sources ranging from financial institutions to social media platforms. Furthermore, in some embodiments, the third-party service serves as an intermediary between the financial services platform and the external data sources. This intermediary role can simplify data management, privacy compliance, and security considerations. The service may implement, for example, robust data protection measures, ensuring that sensitive user information is handled with the utmost care and in accordance with relevant regulations.

In various embodiments, the third party service may provide structured data feeds, APIs, or data streams that deliver the relevant information in a format conducive to further processing. This presentation layer may streamline the integration of external data into the user profile generation process.

At step 320, the system generates or updates a user profile from the unstructured data. Upon extracting unstructured data from external sources closely associated with the user, such as financial transaction data and social media engagement data, the method progresses to either the generation of a new user profile, or the updating of an existing user profile. In various embodiments, this user profile can encompass various aspects of the user based on the unstructured data, such as, e.g., the user's online presence, demographic information, interests, preferences, and behaviors. The aim is to create a comprehensive and dynamic snapshot of the user's digital interactions, affiliations, and personal attributes.

In some embodiments, the system generates a user profile for a new user by incorporating information and data the system has received about the user. In some embodiments, this information includes one or more pieces of information that the user has provided manually to the system in response to one or more, e.g., prompts, text fields, or other invitations for the user to provide information. In some embodiments, the unstructured data extracted from external sources in the previous step is incorporated into the new user profile. In some embodiments, a user profile is updated for an existing user based on updated or additional unstructured data extracted from external sources.

In some embodiments, the system harnesses natural language processing techniques to analyze textual content extracted from the unstructured data. This linguistic analysis allows the method to discern, for example, sentiment, topics, and entities within the user's posts, comments, and interactions. In some embodiments, the process of structuring the unstructured data involves normalizing and categorizing information within a standardized format for user profiles. The result is a profile that reflects not only the user's preferences but also, for example, their emotional inclinations, professional affiliations, and/or personal interests.

To create a unified user profile, the method integrates data from various external sources. This enables the profile to capture the user's interactions and affiliations across multiple platforms, forming a cohesive narrative of their digital identity. Furthermore, in various embodiments, the user profile might include a multitude of information, such as, e.g., demographic details, interests, and inferred preferences, allowing it to offer a multidimensional representation of the user's persona.

In some embodiments, generating the user profile includes structuring the unstructured data to be normalized within a format for user profiles. This transformation process involves imposing a sense of order upon the unstructured data. In various embodiments, this is achieved by applying techniques such as, e.g., data parsing, categorization, and standardization. The unstructured data is dissected, and its elements are categorized into relevant attributes or fields that align with the components of a user profile.

In some embodiments, normalization ensures that the structured user profile adheres to a standardized format that is consistent across all user profiles. In various embodiments, this format may include fields such as, for example, user demographics, interests, financial behavior, and social engagement. By adhering to a standardized structure, the user profiles become amenable to analysis, comparison, and targeted processing.

In some embodiments, the system authenticates the user within the financial services platform prior to performing any additional steps. Authentication involves verifying the identity of the user accessing the platform, i.e., verifying that the user actually is who the user claims to be. This verification process prevents unauthorized access, safeguards user data, and ensures that the interactions within the platform are conducted by legitimate users. Authentication methods can encompass a range of techniques, including, for example, passwords, biometrics, two-factor authentication, and cryptographic tokens.

In some embodiments, this authentication influences subsequent steps in the method, such as risk assessment, financial offer presentation, and user interaction. In some embodiments, a securely authenticated user profile forms the basis for tailored financial offers, ensuring that the offers are presented to the right user and align with their preferences, behavior, and interests. In addition, authentication contributes to user trust and platform credibility. Users can be confident that their interactions within the platform are secure, and their personal and financial information is safeguarded. This sense of security fosters positive user experiences, engagement, and long-term use of the financial services platform.

In some embodiments, the user profile includes a user risk assessment. In some embodiments, this user risk assessment has been previously performed by the system for an existing user. In some embodiments, an existing user risk assessment may be periodically updated to incorporate and factor in new information from the unstructured data the system has received. In some embodiments, for a new user having no previous user account or profile in the platform, the system is configured to perform a user risk assessment based on the unstructured data and any other pieces of information about the user received by the system. This assessment is designed to evaluate the potential risk associated with offering financial services to the user.

At its core, the user risk assessment leverages the comprehensive user profile to analyze a multitude of factors. In various embodiments, these factors may include one or more of, e.g., the user's financial behaviors, spending patterns, transaction history, credit history, credit utilization, and other relevant financial data derived from the user's profile. This data-driven approach allows the method to create a dynamic assessment that is tailored to the user's financial attributes and behaviors.

In some embodiments, by periodically conducting this risk assessment, the method adapts to changes in the user's financial situation over time. For example, if the user's financial behaviors change, such as an increase in credit card spending or a significant purchase, the risk assessment will reflect these adjustments.

In various embodiments, the user risk assessment process relies on one or more of: mathematical models, machine learning algorithms, and/or statistical analysis in order to compute a risk score or classification. This score quantifies the user's creditworthiness, reliability, and potential to fulfill financial obligations.

In various embodiments, the results of the user risk assessment have a direct impact on subsequent stages of the method. These results inform the selection of financial offers that are presented to the user, allowing for tailored and appropriate offerings based on the user's risk profile. The dynamic nature of the assessment ensures that the platform remains responsive to shifts in the user's financial behaviors and circumstances.

In some embodiments, the user risk assessment serves as a means to mitigate potential risks for the financial services platform and associated brands. It enables the platform to make informed decisions about extending financial offers to users while considering their risk profiles. In some embodiments, this risk assessment process aligns with regulatory compliance and responsible lending practices, ensuring that financial offers are extended in a manner that reflects the user's financial capacity.

In some embodiments, the system interactively prompts the user to provide one or more pieces of information missing from the user profile and the financial activity. In scenarios where certain data points are missing from the user profile or financial activity, the platform initiates an interactive dialogue with the user. In some embodiments, this dialogue takes the form of prompts that guide the user to provide the necessary information. These prompts can manifest as questions, requests for documentation, or clarifications aimed at eliciting accurate and relevant responses from the user. The interactivity of this step empowers users to actively contribute to the refinement of their profiles. Users have the opportunity to provide context, updates, or specific details that might not have been captured by automated data retrieval methods. By soliciting input directly from users, the platform achieves a higher degree of data accuracy and personalization.

In some embodiments, the prompts are tailored to the context of the missing information. For example, if the user's job title is missing from their profile, a prompt might ask them to provide their current occupation. Similarly, if a recent financial transaction is not captured, the user could be prompted to confirm the transaction details. In some embodiments, the conversational nature of the prompts is designed to mimic natural interactions and encourage user participation. This engagement fosters a sense of ownership over the data and the user profile, ultimately enhancing the user's overall experience within the financial services platform.

Moreover, the interactive prompts can be implemented through a variety of mediums, including, for example, text-based interfaces, chatbots, voice assistants, or even email communications. This flexibility ensures that users can engage with prompts in a manner that aligns with their preferences and convenience.

In some embodiments, interactively prompting the user is performed via a conversation-based generative artificial intelligence (AI) model. Conversation-based generative AI models, such as Large Language Models (hereinafter “LLMs”), are designed to engage users in natural language conversations. These models leverage sophisticated machine learning techniques to understand user intents, generate contextually relevant responses, and facilitate dynamic dialogues. They simulate human-like conversations, enabling a seamless and intuitive interaction between users and the platform. In this context, these AI models may take on the role of prompting users for missing information. The prompts are generated in a conversational style that aligns with the user's preferences and the context of the missing data. For instance, if the platform requires clarification about a recent transaction, the AI model might initiate a conversation by asking, “Could you please provide more details about the transaction on September 21?” This conversation-based approach ensures that users can engage with the prompts in a natural and user-friendly manner. Instead of encountering rigid forms or static questions, users experience an interactive dialogue that adapts to their responses and provides a more intuitive and comfortable interaction.

Moreover, in some embodiments, conversation-based AI models enable a consistent and scalable approach to user engagement. These models can handle a wide range of prompts, questions, and responses, accommodating diverse scenarios and user preferences. This scalability ensures that the platform can effectively interact with a large user base while maintaining a high degree of personalization.

The integration of AI models in some embodiments has implications beyond user prompts. These models can also contribute to a more holistic understanding of user behavior, preferences, and intentions. By analyzing the user's responses and interactions, the platform can refine its user profiles, tailor financial offers, and continually improve the user experience. In some embodiments, such generative AI models are configured such that they continue to evolve, becoming increasingly adept at understanding context, nuance, and intent in user interactions. This alignment ensures that the prompts are accurate, relevant, and aligned with the user's needs.

In some embodiments, the risk assessment is performed by analyzing user financial activity data, extracted from the user profile generated as described in earlier claims. The data encompasses a spectrum of financial behaviors, including, e.g., transaction history, spending patterns, and income sources derived from the user's financial accounts. For example, transaction history provides insights into the user's spending habits, showcasing their expenditures across different categories. Spending patterns further illuminate the consistency and regularity of financial activities, offering a window into the user's financial stability. Moreover, income sources play a critical role in understanding the user's financial capacity. By discerning where their income originates, the method gains insights into the user's financial trajectory and potential resources. The combination of these data points creates a comprehensive portrait of the user's financial situation.

In some embodiments, performing the risk assessment includes considering credit history and credit utilization of the user. Credit history, a record of the user's past borrowing and repayment behaviors, offers insights into their reliability as a borrower. Credit utilization, which measures the extent of credit currently used in relation to available credit limits, provides a gauge of the user's financial leverage.

At step 330, the system presents, to the user, a financial offer for a financial service or product. In some embodiments, the financial offer and the specific financial service or product offered to the user are selected for the user based on at least the user profile. In some embodiments, this includes the user risk assessment being taken into account. One example of a financial offer which may be taken into account is an offer to the user of a credit card account, where the credit card features a “cashback rewards” program. For example, the credit card may offer a percentage or flat sum of money back to the user on eligible purchases of goods or services made by the cardholder. Some or all of such eligible purchases may be presented to the user via the financial services platform. Another example of an offer may be a credit card where the user's credit limit can be increased based on certain purchases of goods or services from brands presented through the financial services platform. Another possible feature of such a credit card may be increases of overdraft limits which can be accrued through similar purchases. Another example may be the approval or pre-approval of a loan if the user agrees to participate in or accept one or more offers for goods or services via the platform.

In some embodiments, these financial offers are meticulously curated based on the amalgamation of insights from the user profile and the outcomes of the user risk assessment. In some embodiments, each financial offer corresponds to a potential financial product or service, and these offers are presented to the user within the context of their interactions with the financial services platform. The selection of these offers is governed by a data-driven approach that aligns one or more of the user's financial behaviors, preferences, and/or risk profile with the available offerings.

In some embodiments, the process involves mapping the user's characteristics, as captured in the user profile, to a diverse array of financial products or services. This mapping considers factors such as, e.g., the user's risk assessment results, demographic information, interests, and preferences. The aim is to provide the user with financial offers that are tailored to their unique financial needs, capacity, and goals.

In various embodiments, a financial offer may be tied to the concept of invitational content being presented to the user via the financial services platform. This means that the user's engagement with a financial offer that has been accepted, or ability to accept a financial offer, may be linked to their interaction with certain pieces of invitational content associated with specific brands. The synergy between these elements creates an ecosystem where the user's engagement with invitational content can translate into tangible financial benefits. Steps featuring the user matching with and being presented with invitational content will be further explored below.

At step 340, upon receiving an indication of interest from the user, the system matches, based on the user profile and the user risk assessment, the user to one or more pieces of invitational content each associated with a brand and corresponding to a product or service offer from the brand. In some embodiments, once the user profile is generated from the extracted unstructured data, it serves as a rich source of information about the user's preferences, interests, and behaviors. Leveraging this user profile, the method employs a data-driven approach to discern the most relevant and engaging pieces of invitational content that align with the user's attributes.

In some embodiments, the receipt of the user's indication of interest toward the financial offer serves as indication to the system that the user may potentially wish to proceed with the presented offer. In some embodiments, an indication of interest may not necessarily mean that the user will proceed with a full acceptance of the financial offer, but rather is an indication that user is interested in learning more about the terms, details, or requirements of the offer. In some embodiments, a user merely interacting or engaging with the financial offer being presented, such as clicking on a user interface element associated with the offer, may be enough to indicate interest on the part of the user. Upon this indication of interest being received, the system proceeds with matching invitational content to the user.

In various embodiments, this matching process involves a combination of algorithms, data analysis, and brand affiliation to ensure a tailored experience for the user. In some embodiments, the user profile acts as a dynamic filter that refines a vast array of invitational content down to a selection that resonates with the user's individuality.

In some embodiments, these pieces of invitational content often consist of, e.g., offers, promotions, or opportunities provided by brands. In some embodiments, these offers are strategically selected to align with the user's identified interests and preferences, ensuring a higher likelihood of engagement.

In various embodiments, the matching process is performed with various factors taken into account, such as, for example, the user's interactions with the financial services platform, their expressed preferences, and their behavioral patterns. These data-driven insights enable the platform to optimize the selection of invitational content, enhancing the user's experience and increasing the likelihood of successful engagement. In some embodiments, the risk assessment is taken into account in order for the system to assess which pieces of invitational content may be most likely for the user to be able to complete a purchase on or which offers are best suited to their particular risk level.

In some embodiments, matching the user to one or more pieces of invitational content is performed via one or more APIs for an ad network associated with the brand. The system thus can leverage APIs, which serve as conduits for data exchange and interaction, to seamlessly integrate with these ad networks. This integration empowers the system to access a diverse array of invitational content from different brands.

The utilization of APIs emphasizes the system's agility and capacity to adapt to the dynamic landscape of brands and their campaigns. As brands modify their offerings and strategies, the system can readily tap into these changes through APIs, ensuring users are presented with the most relevant and up-to-date invitational content.

At step 350, the system presents the one or more matching pieces of invitational content to the user. This step involves delivering personalized content to the user based on their user profile and risk assessment.

In some embodiments, once the user has been matched with specific pieces of invitational content suited to the user, the financial services platform proceeds to present this relevant invitational content to the user. This content can take various forms, including, e.g., advertisements, promotional offers, or recommendations related to products or services from various brands. In some embodiments, the content presented is personalized to the user. It is selected based on the user's profile, which may include various information about, e.g., their demographics, financial habits, and preferences. Additionally, the user's risk assessment may influence the type of content presented. For instance, a user assessed as having a higher risk tolerance might be shown investment opportunities, while a user with a lower risk tolerance might see savings account offers. In some embodiments, this relates not only to the types of invitational content the user is matched with, but also with how the invitational content is presented to the user. For example, the types of rich media content (e.g., images), phrasing and textual content, and more aspects chosen to be presented to the user may vary depending on these pieces of information and the user risk tolerance.

At step 360, upon receiving indication that the user has accepted the product or service offer for one of the pieces of invitational content, the system receives a fee from the brand, wherein at least a portion of the fee from the brand is used to fund one or more aspects of the financial service or product. In various embodiments, the system receives indication of acceptance of the invitational content from the user in different ways. In some embodiments, the user purchases a product or service associated with the presented invitational content through a brand's website or e-commerce platform, and the brand sends a notification to the system that the user has completed a sale for the product or service. In some embodiments, an API associated with the brand is used by the system to request and/or receive notice when a sale is completed. Upon such indication, the system receives a prespecified amount of funds from the brand associated with that product or service and that presented piece of invitational content. These funds constitute a fee which has been previously agreed upon between the brand and one or more hosts of the system, such that if a user presented with invitational content purchases products or services as a result of being presented with that invitational content, then the system receives fees from the brand thereafter.

At least a portion of the fee from the brand is used to fund one or more aspects of the financial service or product that was presented to the user in step 330. In some embodiments, these funds serve as the financial backing that supports the provision of the financial product or service to the user. The involvement of the brand in funding the offer signifies a partnership where the brand subsidizes the financial product or service as part of their marketing strategy. In some embodiments, with the necessary funds secured, the platform can proceed to deliver the selected financial product or service to the user. In some embodiments, a user acceptance of the financial offer may be necessary before the financial product or service is provisioned to the user, while in other embodiments, indication that the fees have been received from the brand is enough to provision the financial product or service to the user. This provision can manifest in various forms, depending on the nature of the financial offer and the preferences of the user. Whether it involves, for example, providing the user with a credit card with specific terms, granting a credit limit increase, providing preferential interest rates, offering tailored financial products, offering cashback rewards, or similar financial services or offers, the platform ensures that the user receives the promised benefits. The funds received from the brand are used at least in part to provision such services to the user.

In some embodiments, one or more AI models associated with one or more of the matching of the user with invitational content, presenting of invitational content, and/or the presenting of financial offers to the user learn and improve understanding of the user's preferences based on the acceptance of the invitational content or purchase of the related product or service from the user, such that the matching and presenting are more narrowly tailored to the user's interests. In some embodiments, these AI models are designed to operate in a feedback-driven cycle. When a user accepts an offer within presented invitational content by, e.g., completing a purchase, this acceptance triggers a feedback loop. The AI models leverage this feedback to enhance their understanding of the user's preferences, interests, and behaviors. This iterative learning process is instrumental in tailoring subsequent interactions to align more closely with the user's specific preferences.

In some embodiments, as users interact with the platform, purchase products or services through the platform's presented invitational offers, and are provisioned with financial services or products, the AI models analyze patterns and correlations within the user's behaviors. These models discern which types of invitational content and financial offers resonate most effectively with each user. As a result, the AI models progressively fine-tune their predictions and recommendations, leading to a more personalized and engaging experience for users. Furthermore, this embodies a continuous improvement process. As users engage with the platform over time, the AI models become increasingly adept at predicting users' responses and shaping their interactions. This dynamic adaptation ensures that the platform remains relevant and engaging, even as user preferences evolve.

In some embodiments, the system determines one or more user preferences or dislikes related to one or more of: invitational content to be matched with the user or financial offers to be presented to the user; and takes the preference or dislike into account during matching of the user to invitational content or presenting of financial offers to the user. For example, these preferences or dislikes may be derived via one or more AI models from the unstructured content extract from, e.g., social media, financial records, and other sources. For example, if the user has previously spent money in a store that specializes in outdoor activities (e.g., hiking or camping), the system may present invitational content offering a subscription to a mobile application that presents hiking trail recommendations to the user and connects them to a community that shares similar interests. In another example, the system may extract unstructured data from the user's social media profiles to analyze a posting of a recent hiking trip to the Adirondack mountains, and subsequently present a similar offer of a subscription to a mobile application with trail recommendations.

In some embodiments, users are presented with choices, enabling them to indicate their preferences or dislikes concerning invitational content or financial offers. This interactive element enhances the platform's transparency and empowers users to have a say in the type of content they encounter. In some embodiments, through this UI interaction, users can tailor their experience to their unique interests and preferences. For example, if a user holds a strong affinity for certain brands or has particular financial goals, they can indicate their preferences. Conversely, if they wish to avoid specific content, they can express their dislikes. This customizable approach ensures that the content presented aligns more closely with each user's individual preferences.

In some embodiments, the preferences and dislikes expressed by users serve as valuable data points that inform subsequent interactions. The system can ensure that the user inputs are taken into account during the process of matching users with invitational content or presenting financial offers. This integration of user input in the decision-making process enhances the accuracy of recommendations and increases the likelihood of user engagement.

In some embodiments, taking the preference or dislike into account is performed via assigning a positive or negative weight value to one or more pieces of invitational content or financial offers with respect to the user's preferences or dislikes. This introduces a methodological refinement that operationalizes the user preferences and dislikes expressed within the user interface interaction. This refinement involves the assignment of positive or negative weight values to pieces of invitational content or financial offers, aligned with the user's indicated preferences or dislikes. This mechanized approach adds a layer of quantitative precision to the process, ensuring that user inputs are translated into actionable adjustments.

In some embodiments, when a user indicates a preference for certain types of invitational content or financial offers, a positive weight value is assigned to these selections. Conversely, if the user expresses a dislike for particular content, a negative weight value is assigned. These weight values serve as indicators of user inclination or aversion. The mechanism then integrates these weight values into the platform's recommendation algorithms. When matching users with invitational content or presenting financial offers, the algorithm accounts for the assigned weight values. Content that aligns positively with user preferences receives a boost in relevance, while content that corresponds to user dislikes is deprioritized.

In some embodiments, presenting the financial offers to the user includes offering one or more of: credit limit increases, preferential interest rates, or tailored financial products. Credit limit increases serve as a foundational offering, enabling users to access higher credit limits based on their financial behaviors and risk assessment. By providing this option, the system acknowledges the dynamic nature of users' financial needs and their evolving capacity to manage credit. Preferential interest rates signify another layer of customization. The system can propose interest rates that align with the user's risk profile and financial history. This personalized approach not only reflects industry trends but also empowers users to make more informed decisions about borrowing. Tailored financial products emerge as a pinnacle of personalization. The system can craft unique financial products based on user preferences and risk assessments. This level of customization transforms the system from a mere platform to an adaptive financial partner, capable of delivering solutions finely attuned to the user's circumstances.

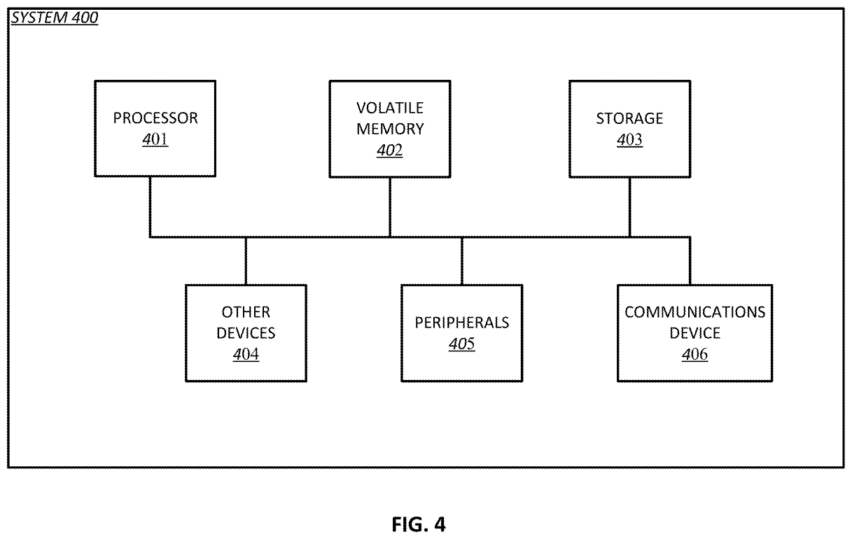

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for provision of financial services within a financial services platform, comprising:
extracting unstructured data from one or more external sources associated with a user, wherein the user is one of: a new user of a financial services platform, or an existing user of the financial services platform;
generating or updating a user profile from the unstructured data, the user profile comprising a user risk assessment;
presenting, to the user, a financial offer for a financial service or product;
upon receiving an indication of interest from the user, matching, based on the user profile and the user risk assessment, the user to one or more pieces of invitational content each associated with a brand and corresponding to a product or service offer from the brand;
presenting the one or more matching pieces of invitational content to the user;
upon receiving indication that the user has accepted the product or service offer for one of the pieces of invitational content, receiving a fee from the brand, wherein at least a portion of the fee from the brand is used to fund one or more aspects of the financial service or product; and
periodically performing one or more of the above steps for additional financial offers and additional pieces of invitational content.

2. The method of claim 1, wherein the data from the external sources comprise one or more of:
financial transaction data and social media engagement data.

3. The method of claim 1, wherein the data from the external sources is retrieved and presented by a third party service.

4. The method of claim 1, wherein generating the user profile comprises structuring the unstructured data to be normalized within a format for user profiles.

5. The method of claim 1, further comprising:
authenticating the user within the financial services platform.

6. The method of claim 1, further comprising:
interactively prompting the user to provide one or more pieces of information missing from the user profile.

7. The method of claim 6, wherein interactively prompting the user is performed via a conversation-based generative artificial intelligence (AI) model.

8. The method of claim 1, wherein one or more AI models associated with the matching of the user with invitational content and the presenting of financial offers to the user learn and improve understanding of the user's preferences based on the acceptance of the financial offer from the user, such that the matching and presenting are more narrowly tailored to the user's interests.

9. The method of claim 1, further comprising:
determining, via one or more AI models, one or more user preferences or dislikes related to one or more of: invitational content to be matched with the user or financial offers to be presented to the user; and taking the preference or dislike into account during matching of the user to invitational content or presenting of financial offers to the user, wherein the determining is based on the extracted unstructured data.

10. The method of claim 1, further comprising:
upon receiving the fee from the brand, provisioning the financial service or product to the user.

11. The method of claim 1, wherein generating the user profile comprises using natural language processing techniques to analyze text from the extracted unstructured data.

12. The method of claim 1, wherein the user profile comprises one or more of: demographic information, interests, and preferences inferred from the extracted unstructured data.

13. The method of claim 1, wherein performing the user risk assessment comprises analyzing user financial activity data from the user profile, the user financial activity data comprising one or more of: transaction history, spending patterns, and income sources from one or more financial accounts of the user.

14. The method of claim 13, wherein the user risk assessment comprises a credit history of the user.

15. A system for provision of financial services within a financial services platform, the system comprising one or more processors configured to perform the operations of:
extracting unstructured data from one or more external sources associated with a user, wherein the user is one of: a new user of a financial services platform, or an existing user of the financial services platform;
generating or updating a user profile from the unstructured data, the user profile comprising a user risk assessment;
presenting, to the user, a financial offer for a financial service or product;
upon receiving an indication of interest from the user, matching, based on the user profile and the user risk assessment, the user to one or more pieces of invitational content each associated with a brand and corresponding to a product or service offer from the brand;
presenting the one or more matching pieces of invitational content to the user;
upon receiving indication that the user has accepted the product or service offer for one of the pieces of invitational content, receiving a fee from the brand, wherein at least a portion of the fee from the brand is used to fund one or more aspects of the financial service or product; and
periodically performing one or more of the above steps for additional financial offers and additional pieces of invitational content.

16. The system of claim 15, wherein presenting the financial offer to the user comprises offering one or more of: a credit limit increase, a cashback reward, or a tailored financial product.

17. The system of claim 15, wherein matching the user to one or more pieces of invitational content is performed via one or more Application Programming Interfaces (APIs) for an ad network associated with the brand.

18. The system of claim 15, wherein the one or more processors are further configured to perform the operation of:
monitoring the user's engagement with the presented financial offers and adjusting the user profile accordingly.

19. The system of claim 15, wherein the user profile is continuously or periodically updated based on changes in one or more of: the user's financial activity data and social media engagement data.

20. A non-transitory computer-readable medium containing instructions for provision of financial services within a financial services platform, comprising:
instructions for extracting unstructured data from one or more external sources associated with a user, wherein the user is one of: a new user of a financial services platform, or an existing user of the financial services platform;
instructions for generating or updating a user profile from the unstructured data, the user profile comprising a user risk assessment;
instructions for presenting, to the user, a financial offer for a financial service or product;
upon receiving an indication of interest from the user, instructions for matching, based on the user profile and the user risk assessment, the user to one or more pieces of invitational content each associated with a brand and corresponding to a product or service offer from the brand;
instructions for presenting the one or more matching pieces of invitational content to the user;
upon receiving indication that the user has accepted the product or service offer for one of the pieces of invitational content, instructions for receiving a fee from the brand, wherein at least a portion of the fee from the brand is used to fund one or more aspects of the financial service or product; and
instructions for periodically performing one or more of the above steps for additional financial offers and additional pieces of invitational content.
